(19) United States
(12) Patent Application Publication
(10) Pub. No.: US 2025/0254528 A1
(43) Pub. Date: Aug. 7, 2025

(54) COEXISTENCE OF UWB AND WI-FI OPTIMIZATIONS

(71) Applicant: Cisco Technology, Inc., San Jose, CA (US)

(72) Inventors: Jerome HENRY, Pittsboro, NC (US); Robert E. BARTON, Richmond (CA); Rabe ARSHAD, Milpitas, CA (US); Peiman AMINI, Fremont, CA (US); Ardalan ALIZADEH, Campbell, CA (US)

(21) Appl. No.: 18/435,622

(22) Filed: Feb. 7, 2024

(51) Int. Cl. H04W 16/14

(52) U.S. Cl. CPC H04W 16/14

(57) ABSTRACT

Techniques for optimizing the coexistence of UWB and Wi-Fi transmissions are provided. A synchronization schedule is received from an Ultra-wideband (UWB) network device. The synchronization schedule is analyzed to determine one or more timings for one or more UWB transmissions. A schedule for one or more Wireless Local Area Network (WLAN) transmissions is adjusted to avoid interference with the one or more UWB transmissions. The adjusted schedule for the one or more WLAN transmissions is communicated to a WLAN device.

### TECHNICAL FIELD

Embodiments presented in this disclosure generally relate to wireless communication. More specifically, the embodiments disclosed herein relate to optimizing the coexistence of ultra-wideband (UWB) and Wi-Fi transmissions.

### BACKGROUND

Wireless access points (APs) with ultra-wideband (UWB) radios offer the capability to track people, assets, and devices with high precision, achieving an accuracy of a few centimeters. The integration of UWB with Wi-Fi technology introduces many new functions, including gathering the precise location of APs, tracking assets in real time, monitoring in-building human occupancy, indoor navigation, and much more.

According to the Federal Communications Commission (FCC) guidelines, the UWB frequency spectrum ranges from 3.1 GHz to 10.6 GHz. Within the current system, the most commonly used UWB channels are channels 5 and 9. Experiments in office settings have indicated that using channel 5 for UWB transmission can lead to range improvements of up to 1.25 times. However, a major challenge arises from the coexistence of UWB and Wi-Fi technologies. This is due, in part, to the fact that UWB channel 5 operates in the 6 GHz band, which is also the frequency range used by Wi-Fi 6E (and later versions). Furthermore, UWB channels typically span 500 MHz, which is substantially wider than Wi-Fi channels. Moreover, Wi-Fi signals are broadcasted at much higher power levels compared to UWB. The proximity of their operational frequencies, combined with the differences in bandwidth and transmission power, may lead to severe interference between the two systems and, as a result, deteriorate the performance of both the UWB system(s) as well as the Wi-Fi system(s).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment where Wi-Fi and UWB technologies coexist, according to some embodiments of the present disclosure.

FIG. 2A depicts the overlapping channels employed by Wi-Fi and UWB devices, according to some embodiments of the present disclosure.

FIG. 2B depicts an example UWB packet structure, according to some embodiments of the present disclosure.

FIG. 3 depicts an example network infrastructure that integrates UWB and Wi-Fi technologies within a shared environment, according to some embodiments of the present disclosure.

FIG. 4 depicts a sequence for UWB anchor synchronization and dynamic radio resource management (RRM), according to some embodiments of the present disclosure.

FIG. 5 depicts a sequence for zone-of-non-interference-based (ZNI-based) dynamic radio resource management (RRM), according to some embodiments of the present disclosure.

FIG. 6 depicts an example method for adjusting Wi-Fi transmission based on a shared UWB synchronization schedule, according to some embodiments of the present disclosure.

FIG. 7 depicts an example method for frequency-domain puncturing based on defined ZNIs and a shared UWB synchronization schedule, according to some embodiments of the present disclosure.

FIG. 8 is a flow diagram depicting an example method for optimizing the coexistence of ultra-wideband (UWB) and Wi-Fi transmissions, according to some embodiments of the present disclosure.

FIG. 9 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving a synchronization schedule from an ultra-wideband (UWB) network device, analyzing the synchronization schedule to determine one or more timings for one or more UWB transmissions, adjusting a schedule for one or more Wireless Local Area Network (WLAN) transmissions to avoid interference with the one or more UWB transmissions, and communicating the adjusted schedule for the one or more WLAN transmissions to a WLAN device.

Other embodiments in this disclosure provide one or more non-transitory computer-readable mediums containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### EXAMPLE EMBODIMENTS

The present disclosure provides techniques designed to manage and optimize the coexistence of UWB and Wi-Fi communications within a shared network environment. More specifically, embodiments of the present disclosure introduce various methods to enhance the operations of UWB or Wi-Fi systems, or both, for the purpose of mitigating interference and improving the network's overall performance.

In some embodiments of the present disclosure, a UWB system (including one or more primary anchors, one or more responding anchors, and/or one or more tags) may transmit synchronization schedules to a Wi-Fi device (e.g., a primary access point (AP) or a wireless controller (WLC) managing multiple APs, where applicable). Utilizing the information, the Wi-Fi device may dynamically adjust the allocation of radio resources to avoid conflict with UWB transmissions. For example, in some embodiments, the Wi-Fi device may modify its transmission timings to prevent overlapping with UWB communication windows. In some embodiments, the Wi-Fi device may also refine its channel selection strategies for Wi-Fi signals. Such refinements may include refraining from using UWB channel 5 to eliminate (or at least reduce) interference. In embodiments where complete avoidance is not feasible or preferred, the Wi-Fi device may limit the overlap by choosing Wi-Fi channels where the primary 20 MHz band falls outside of UWB channel 5.

In some embodiments of the present disclosure, the Wi-Fi device (e.g., the primary AP or the WLC) may establish a zone of non-interference (ZNI) for each UWB anchor. Within these zones, the radio frequencies used by UWB may be protected, effectively preventing their use for Wi-Fi transmissions (in some embodiments, such techniques may alternatively be referred to as frequency-domain puncturing). For example, in some embodiments, APs and their associated stations (STAs) (or client devices) within a ZNI may be instructed to refrain from using any segment of Wi-Fi channels that overlaps with UWB channel 5. In embodiments where creating a perfect ZNI is challenging, some APs within the ZNI may be allowed to utilize segments of Wi-Fi channels overlapping with UWB channel 5. In these configurations, since the Wi-Fi channel is narrower in bandwidth compared to the UWB channel, UWB signals can still be properly received if the overlapping segments are strategically limited. In some embodiments, the frequency-domain puncturing technique may be augmented with time-domain puncturing. For example, based on the synchronization schedule provided by UWB anchors and the detected activity of UWB tags, Wi-Fi transmissions within a ZNI may be programmed to temporarily halt on segments that overlap with UWB channel 5, specifically during periods of active UWB transmissions.

In some embodiments of the present disclosure, the UWB packet structure may be adjusted for improved performance. For example, UWB anchors may incrementally increase the length of the Synchronization Header (SHR) in UWB packets. The increased SHR length may enhance UWB ranging accuracy, as it allows for better synchronization and easier detection of the start of a frame, particularly in environments with dense Wi-Fi transmissions.

In some embodiments of the present disclosure, UWB devices (e.g., UWB anchors, UWB tags) may dynamically modify the threshold for Channel Impulse Response (CIR) peak selection based on Wi-Fi transmission density. For example, in low-density Wi-Fi environments, UWB devices may lower the threshold to make them more sensitive to weaker signals, whereas in high-density Wi-Fi environments, UWB devices may raise the threshold to filter out noise and prevent false positives. The dynamic adjustment of the CIR peak selection threshold may enable UWB devices to effectively distinguish UWB signals from Wi-Fi signals in a shared environment, and therefore improve the reliability of UWB communications.

In some embodiments of the present disclosure, beamforming techniques may be used to mitigate interference between Wi-Fi and UWB signals. For example, by learning the positions of UWB devices, APs may direct null steering or create null zones towards these devices. Within the null zones, Wi-Fi signals are effectively reduced, therefore minimizing the potential for interference.

In some embodiments of the present disclosure, APs may misrepresent their power state to their associated STAs (or client devices), prompting these devices to respond in a reduced power mode. For example, an AP may report itself as being in a Lower Power Idel (LPI) state while it is, in fact, operating in a Standard Power Idle (SPI) mode. In such configurations, the STAs (or client devices) associated with the AP may transmit responses using a reduce power setting. The Wi-Fi signals with reduced transmit power may therefore reduce the likelihood of interference with UWB transmissions in a shared environment.

Each embodiment of the present disclosure may be implemented independently, or used in conjunction or in combination with other embodiments, for the purpose of enhancing the coexistence and improving the performance of both UWB and Wi-Fi communications.

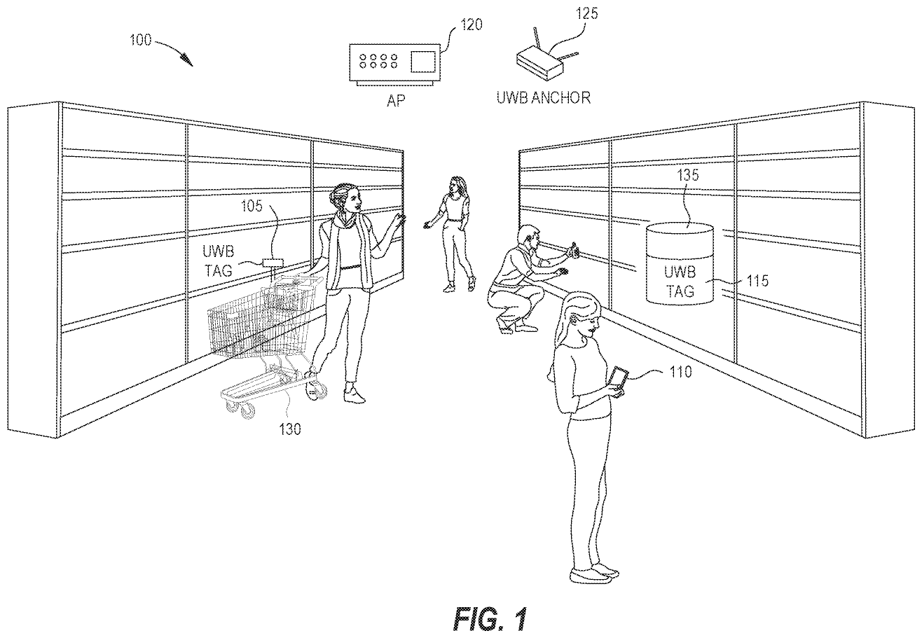

FIG. 1 depicts an example environment 100 where Wi-Fi and UWB technologies coexist, according to some embodiments of the present disclosure.

In the illustration, the example environment 100 corresponds to a retail establishment (such as a grocery store or a shopping mall), and demonstrates the coexistence of UWB and Wi-Fi communication in a real-world setting. Within the environment 100, one or more Wireless Local Area Network (WLAN) access points (APs) 120 and one or more UWB anchors 125 are installed (e.g., on the ceiling).

Within the depicted environment 100, UWB tags are installed or present at various places to enable a wide range of location-based services, such as asset tracking or navigation. In some embodiments, a UWB tag may be integrated into a smartphone 110, which allows for the precise tracking of an individual's location within the environment 100. For example, by communicating with their nearby UWB anchors 125, the UWB-enabled smartphone 110 may facilitate accurate indoor navigation, and/or be used for monitoring in-building human occupancy in real time.

In some embodiments, a UWB tag 115 may be attached to an item 135, to provide real-time information about the location and movement of the item 135 within the environment 100. The collected location data may then be used for management wide variety of operations and systems.

In the illustrated environment 100, the APs 120 are connected to the broader network infrastructure (e.g., Internet) that enables data communication and connectivity. In some embodiments, the UWB anchors 125 may be connected to nearby APs 120, and utilize the network connection for effective data transfer. The integration of UWB anchors 125 with APs 120 may ensure that the location data collected by the UWB system is communicated to a central server or database via the network for further processing. The central server, upon receiving the location data gathered by different UWB anchors 125, may aggregate and analyze the data for advanced applications, including, but not limited to, asset tracking, indoor navigation, and in-building human occupancy monitoring.

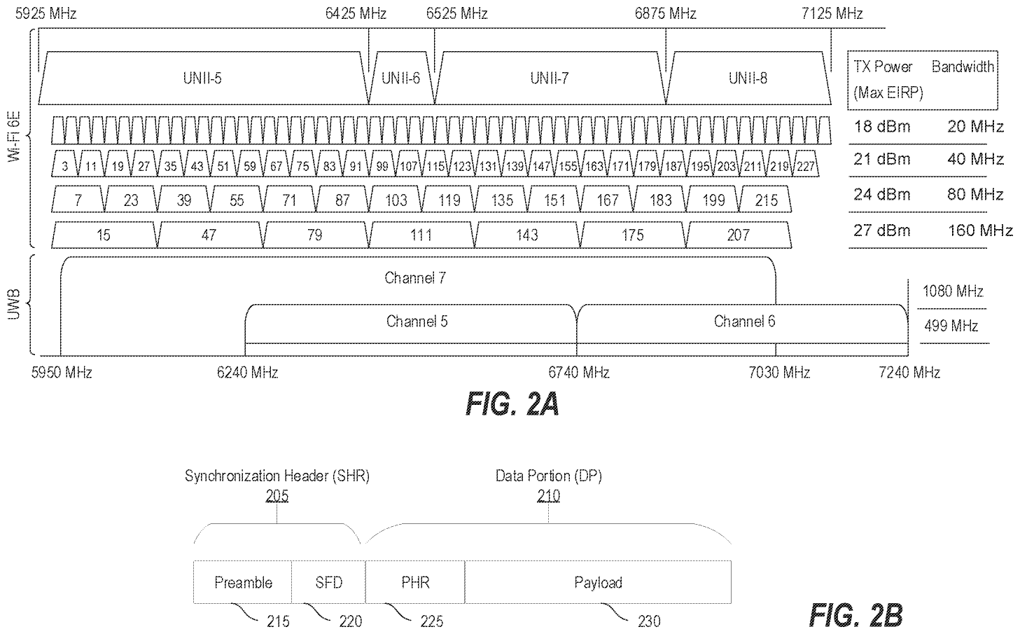

Although the illustrated example depicts the UWB anchor 125 and the AP 120 as two distinct components, the example is only provided for conceptual clarity. In some embodiments, the UWB anchor 125 and the AP 120 may be co-located (e.g., the Wi-Fi and UWB signals may be transmitted and/or received by a single device). FIG. 2A depicts the overlapping channels employed by Wi-Fi and UWB devices, according to some embodiments of the present disclosure.

As illustrated, channels 5, 6, and 7 used by UWB devices are located in the 6 GHz range. Channel 5 for UWB starts above 6.2 GHz and extends to nearly 6.74 GHZ. Channel 6 for UWB begins above 6.74 GHz and extends to nearly 7.24 GHz. Channel 7 for UWB starts from 5.95 GHz and extends to slightly beyond 7.24 GHz. The diagram also depicts the Wi-Fi 6E bands, labeled as UNII-5, UNII-6, UNII-7, and UNII-8. It also shows the maximum transmission power (TX power) allowed in dBm, and the bandwidth in MHz for each of these bands. For example, within the Wi-Fi 6E spectrum, sub-band 3 represents a segment of the spectrum within UNII-5 that is 40 MHz wide, starting from around 5.925 GHz and extends to 5.965 GHz. The Wi-Fi sub-band 15 represents a segment of the spectrum within UNII-5 that is 160 MHz wide, starting from around 5.925 GHz and extending to 6.085 GHz.

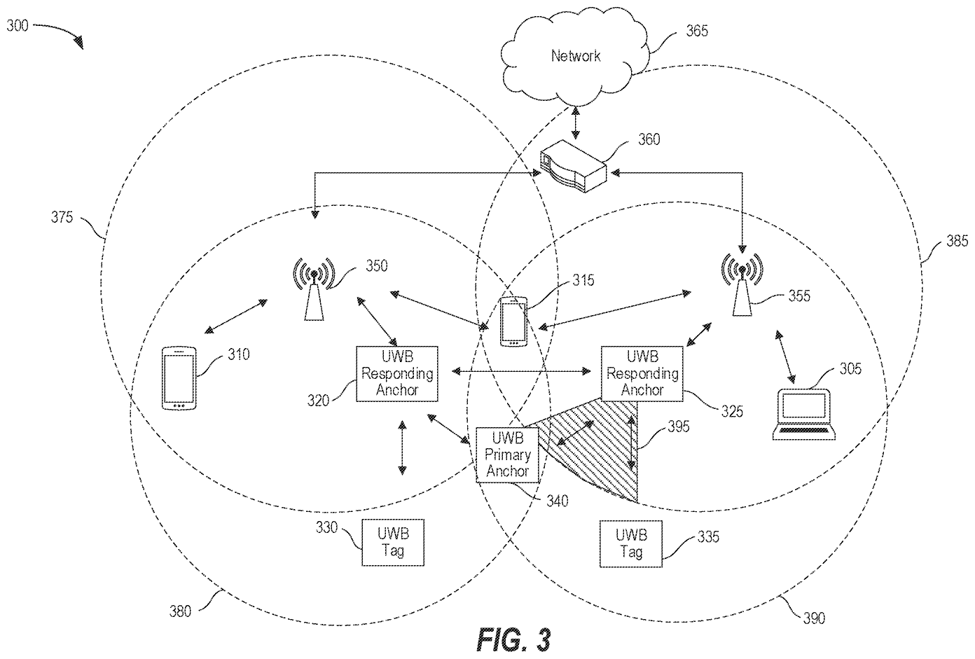

As illustrated, due to their wide bandwidth, UWB channels 5, 6, and 7 share some of the same frequencies as Wi-Fi 6E. For example, UWB channel 5 overlaps with four of the seven Wi-Fi 6E channels that are each 160 MHz wide, including sub-bands 47, 79, 111, and 143. UWB channel 6 overlaps with two of the seven Wi-Fi 6E channels with a 160 MHz bandwidth, including sub-bands 175 and 207. UWB channel 7, which has a bandwidth of approximately 1080 MHZ, overlaps with all seven Wi-Fi 6E channels with 160 MHz bandwidth. The overlap between UWB channels and Wi-Fi 6E bands may lead to interference, which can affect the performance of devices using these technologies. This is particularly relevant in environments (e.g., 100 of FIG. 1) where both UWB and Wi-Fi 6E technologies are utilized at the same time, such as in smart homes, industrial settings, or retail spaces. Therefore, careful planning and coordination are required in the deployment of UWB and Wi-Fi technologies. This may involve selecting the appropriate channels for Wi-Fi transmissions to avoid overlap with UWB operations, reserving certain frequency segments for the exclusive use of UWB, implementing time-division techniques to avoid transmission conflicts, increasing UWB packet length or dynamically adjusting the CIR threshold to improve the reliability of UWB communications, and utilizing beamforming or power control techniques to mitigate potential interferences. More detail is discussed below with reference to FIGS. 3, 4, and 5.

FIG. 2B depicts an example UWB packet structure, according to some embodiments of the present disclosure.

As illustrated, the example UWB packet is divided into two main sections: the Synchronization Header (SHR) 205 and the Data Portion (DP) 210. The SHR 205 further consists of two parts: the preamble 215 and the Start Frame Delimiter (SFD). The preamble 215 contains a sequence of symbols used for timing synchronization and channel estimation. The preamble 215 may be configured with different lengths, indicated by the number of preamble symbol repetitions (PSR). The SFD 220 includes a sequence of symbols that indicates the beginning of the data frame. The SFD 220 allows the UWB receiver to determine the exact start of the data portion 210. The SFD 220 may be repeated several times (e.g., 8 times) to enhance the reliability of packet detection.

Within the example UWB packet, as illustrated, the Data Portion (DP) 210 includes two parts: the PHY Header (PHR) 225 and the Payload 230. In some embodiments, the PHY Header 225 may be a 19-bit header that provides information about the packet, such as its length or data rate. In some embodiments, the PHR 225 itself may be transmitted at a basic rate (e.g., 850 kbps). The payload 230 is the actual data being transmitted, which can be up to 127 bytes in size. In some embodiments, the payload may be transmitted at various data rates (e.g., 110 kbps, 850 kbps).

In some embodiments, such as in dense Wi-Fi networks where there is a high duty cycle and the channels are frequently occupied, UWB devices (e.g., UWB anchor 125 of FIG. 1) may increase the length of the synchronization segment of the UWB packet to improve the robustness of the UWB data transfer. In some embodiments, the adjustment in length may include increasing the length of preamble 215 and/or the repetitions of SFD 220. For example, increasing the length of preamble 215 (which involves increasing the number of PSR) may provide more data for the UWB receiver to use in establishing the timing and frequency synchronization, which may improve the receiver's capability to distinguish the UWB signal from noise (particularly in low signal-to-noise (SNR) conditions or over long distances). More repetitions of the SFD may increase the likelihood of the UWB receiver correctly identifying the start of the data frame, which helps proper packet decoding. The longer the SHR is, the higher the chance that UWB signal can be distinguished from random noise or interference in the communication channel. However, UWB packets with an extended SHR 205 (whether due to longer preamble or more SFD repetitions) also have potential drawbacks, such as that they may consume more time and/or bandwidth for transmission, which can reduce the overall data throughput and increase latency.

In some embodiments, the SHR length (whether the preamble length or the SFD repetitions, or both) may be gradually adjusted depending on several factors, including the specific requirements of the UWB system, the characteristics of the wireless environment (such as low or high density of Wi-Fi networks), the performance and reliability of the UWB communication under the given environmental conditions (e.g., SFD timeout, PHR error, data decoding error), and the design goal of the communication protocol being used. For example, in high-density Wi-Fi networks, where Wi-Fi transmission is more frequent and interference is higher, the length of the SHR may be gradually increased to improve the robustness of the UWB communications, even though it may require additional airtime and potentially reduce throughput. In contrast, in low-density Wi-Fi networks, where there is less interference, the length of the SHR may be kept shorter (or may be reduced) to maintain the throughput without sacrificing reliability. When SFD timeouts occur frequently, it may suggest that the preamble 215 and/or SFD 220 are not be long enough to be reliably detected in the given environment, and thus, their lengths may need to be increased. When a high rate of PHR errors is detected, it may indicate the need for increasing the SHR length to ensure better detection and synchronization. When frequent data decoding errors are detected, it may prompt an increase in SFD repetitions to improve the accuracy of payload data decoding. Through the gradual adjustment, the UWB devices may find a balance for the SHR length that allows for reliable UWB communication without undue impact on network efficiency.

FIG. 3 depicts an example network infrastructure 300 that integrates UWB and Wi-Fi technologies within a shared environment, according to some embodiments of the present disclosure.

The depicted network infrastructure 300 includes access points (APs) 350 and 355. The APs 350 and 355 are both interfaced with a wireless controller (WLC) 360. The WLC 360 may comprise a scheduling and resource engine (SRE) that coordinates the network operations for the APs to ensure efficient communication across the network. AP 350 and AP 355 are configured to communicate with at least one network 365, such as the Internet, or other local area networks (LANs). The connection between the APs 350 and 355 and the WLC 360 facilitates data transmission, allowing the APs 350 and 355 to transmit and receive information to and from stations (STAs) (or client devices) within their respective coverage areas. Additionally, the infrastructure may also provide these devices with wireless access to the network 365. For example, as illustrated, the STAs 310 and 315, and the UWB responding anchor 320 are within the coverage area 375 of AP 350. In this configuration, AP 350 is capable of communicating with each of these devices, whether in uplink or downlink modes, and can also connect these devices to the broader network 365. Similarly, as illustrated, the coverage area 385 of AP 355 includes the STAs 305 and 315, and the UWB responding anchor 325. In this configuration, AP2 can facilitate communications with these devices by managing both uplink data (receiving information from these devices) and downlink data (sending information to these devices). Additionally, AP 355 can provide these devices (within the coverage area 385) with wireless connectivity to network 365. The devices located within the coverage areas of both APs 350 and 355, such as STA 315, may choose to connect to either AP, and may switch between the two APs without losing connectivity.

Within the illustrated network infrastructure 300, each UWB anchor has its own respective signal coverage area (also referred to in some embodiments as zone of detection), within which devices can effectively communicate with the anchor. For example, the UWB responding anchor 320 has a signal coverage area 380, and the UWB responding anchor 325 has a signal coverage area 390. Given that UWB primary anchor 340 falls within both the signal coverage areas 380 and 390, it can transmit synchronization signals to both UWB responding anchors 320 and 325. The messages enable the UWB responding anchors 320 and 325 to synchronize their clocks or other timing-related parameters with the UWB primary anchor 340. When the UWB tag 330 enters the coverage area 380, it can establish communication with the UWB responding anchor 320. This may involve transmitting data to the anchor 320 or enabling the anchor 320 to detect the presence of the tag 330 based on its signal. Similarly, when the UWB tag 335 enters the coverage area 390, it may proceed to communicate with the UWB responding anchor 325. Such communications may be used for applications like asset tracking, indoor navigation, or other location-based services that rely on the precise location and movement data provided by UWB technology.

As illustrated, there is an overlapping area between the signal coverage areas 375 (of AP 350) and 380 (of UWB responding anchor 320). The overlapping area includes STA 310, STA 315, AP 350, and UWB responding anchor 320, which indicates that both Wi-Fi and UWB transmissions coexist in this physical space. As previously discussed, since certain UWB channels share frequencies used by Wi-Fi 6E, there is a potential for interference within this overlapping area. Similarly, potential interference may also arise in the overlapping area between the signal coverage areas 382 (of AP 355) and 390 (of UWB responding anchor 325).

In some embodiments, to mitigate such interference, network configurations may be adjusted. This may involve implementing radio resource management (RRM) strategies, such as dynamic frequency selection (DFS) for Wi-Fi transmissions. For example, the UWB primary anchor 340 may first share a synchronization transmission schedule with the SRE (e.g., with the WLC 360). The schedule details the timings for when the UWB primary anchor 340 plans to transmit synchronization pulse messages, and the timings and sequence in which the UWB responding anchors 320 and 325 are expected to respond. Upon receiving the schedule, the SRE (which is a part of the WLC 360) activates its RRM process, and implements strategies to mitigate potential conflicts between UWB and Wi-Fi communications. In embodiments where UWB operations utilize a channel such as UWB channel 5, the SRE may select Wi-Fi channels that do not overlap with UWB channel 5 entirely. For example, considering UWB channel 5 overlaps with Wi-Fi channels in frequencies from 6240 MHZ to 6740 MHZ, the SRE may choose to utilize Wi-Fi channels like 15, 175, and 207 (as depicted in FIG. 2A), which correspond to the 160 MHz bandwidth segments within the UNII-5, and UNII-7, and UNII-8 bands, where there is no overlap with UWB channel 5.

If complete avoidance is not feasible, the SRE may adjust Wi-Fi channels to minimize overlap. For example, it may select Wi-Fi channels where the primary 20 MHz bandwidth avoids UWB channel 5, limiting the overlap to the extension portion of the channel (like the last 20, 40, 80, or 160 MHZ, depending on the Wi-Fi channel bandwidth). If UWB channel 5 is in use, the SRE may select Wi-Fi channel 47 with a 160 MHz bandwidth (as depicted in FIG. 2A), or Wi-Fi sub-channel 55 with an 80 MHz bandwidth (as depicted in FIG. 2A), as their primary 20 MHz channel is centered on a frequency that falls outside of the UWB channel 5 range (from 6240 MHZ to 6740 MHZ), with only the extended part overlapping.

Additionally, in some embodiments, the SRE may use the shared UWB synchronization schedule to coordinate Wi-Fi transmission opportunities (TXOPs) or resource units (RUs). For example, the SRE may adjust the timings of Wi-Fi transmissions by scheduling Wi-Fi TXOPs during periods when UWB synchronization transmissions are expected to be inactive (based on the shared schedule). In some embodiments, the SRE may allocate Wi-Fi RUs in a manner that avoids simultaneous transmission with UWB synchronization messages. For example, the shared schedule may reveal that the UWB synchronization messages are transmitted at specific intervals. The SRE may allocate TXOPs to Wi-Fi devices so that their transmissions occur between these intervals. The coordination may prevent conflicts with UWB transmissions, and therefore reduce the likelihood of interference and ensure smooth operations of both UWB and Wi-Fi technologies within the network.

In some embodiments, after the SRE (which is part of the WLC 360) has adjusted the Wi-Fi channels and implemented the necessary RRM strategies, the UWB system begins its synchronization operation. This operation ensures that all UWB anchors are precisely aligned in terms of timing, which is important because UWB technology relies on time-of-flight measurements (the time it takes for a signal to travel from the tags to the anchors) to determine the location of UWB tags with high accuracy.

In some embodiments, in addition to synchronization messages, UWB tag transmission may occur in response to specific operational needs or events like asset tracking. When the UWB tag 330 enters the signal coverage zone 380 of the UWB anchor 320, the signal broadcasted by the UWB tag 330 is received by the UWB anchor 320. Based on the received signal (like its strength and time of arrival), the UWB anchor 320 may determine the presence and possibly the location of the UWB tag 330. Upon detecting the UWB tag 330, the UWB anchor 320 may report its presence to the SRE (which is part of the WLC 360). The reporting alerts the SRE to the possibility of UWB tag transmissions occurring at unpredictable intervals in the near future, which may potentially interfere with Wi-Fi operations. The SRE may then use the information received from UWB anchors to adjust its RRM strategies. For example, the adjustment may involve analyzing the impact of current Wi-Fi and UWB operations on each other and making ongoing changes to optimize the coexistence of both technologies. For example, if certain UWB tag transmissions are detected to cause unexpected interference with Wi-Fi channels, the SRE may further adjust Wi-Fi channel assignments. For example, the SRE may avoid overlapping with UWB channel 5 entirely by selecting Wi-Fi sub-channels like 15, 175, and 207 (as depicted in FIG. 2A), in the UNII-5, UNII-7, and UNII-8 bands. The SRE may limit the overlapping to the extension part of Wi-Fi channels, such as choosing Wi-Fi sub-channels like 47 and 55 (as depicted in FIG. 2A), where only the extended bandwidth overlaps with UWB channel 5. The SRE may also modify the timing of Wi-Fi TXOPs and RUs (e.g., scheduling Wi-Fi TXOPs during periods when UWB transmissions are expected to be less frequent or inactive, or allocating Wi-Fi RUs to avoid simultaneous transmission with UWB tags).

In some embodiments, instead of or in addition to relying on broad RRM strategies to adjust the operations of all Wi-Fi devices (including APs 350 and 355, STAs 305, 310, and 315) within the network, a more localized approach may be adopted. This approach involves modifying Wi-Fi operations within specific defined zones of non-interference (ZNI) of each UWB anchor to minimize interference with UWB communications. The SRE (which is a part of WLC 360) may first gather detailed reports from APs 350 and 355 about signal detections in their vicinity. The report may include data about the strength (e.g., RSSI, SNR), frequency, and duration of signals detected, which can be from various sources, including UWB devices (e.g., UWB anchors 320 and 325) and other Wi-Fi devices (e.g., STAs 305, 310, and 315). For example, AP 350 may detect signals from STAs 310 and 315, as well as from UWB responding anchor 320, since these three devices are within the signal coverage 375 of AP 350. Similarly, AP 355 may detect signals from STAs 305 and 315, and from UWB responding anchor 325, as these three devices are within the signal coverage 385 of AP 355. Based on the collected signal reports, the SRE may define ZNIs around each UWB anchor. As used herein, the ZNIs are areas around UWB anchors where signals from the UWB anchors should not be interfered with by other radio frequency sources, such as Wi-Fi signals. The SRE may define the APs (and which subset of their associated clients) within a specific ZNI must be silent over frequency bands overlapping with UWB channels in order for the UWB anchor signals to be received properly. In some embodiments, the ZNI may align with the signal coverage of a UWB anchor. For example, ZNI for UWB responding anchor 320 may align with its signal coverage 380 (which includes AP 350, STAs 310 and 315), and ZNI for UWB responding anchor 325 may align with its signal coverage 390 (which includes AP 355, STAs 305 and 315). In some embodiments, the ZNI may be adjusted based on practical considerations like the layout of the environment, the location of Wi-Fi access points, and the requirements of the UWB applications. In some embodiments, the ZNI may be dynamically adjusted based on real-time monitoring of UWB and Wi-Fi signal quality and the presence of potential interference sources.

In some embodiments, based on the determined ZNIs, the SRE may instruct all Wi-Fi devices (including APs and their associated STAs) to adjust their operations. This may include instructing all APs (and their associated STAs) within the ZNI refrain from using any segment of Wi-Fi channels overlapping with UWB channels. For example, when UWB responding anchor 320 is using UWB channel 5 for synchronization message transmission, the SRE (which is a part of the WLC 360) may instruct AP 350 and STAs 310 and 315 within the ZNI of UWB responding anchor 320 not to use any segment of Wi-Fi channels that overlap with UWB channel 5. In some embodiments, the SRE may allow some APs within the ZNI to use segments overlapping with UWB channels but with reduced power. In such configurations, UWB signals can still be properly received when the overlapping segments are strategically limited (considering that the UWB channel is much broader than the Wi-Fi channel).

In some embodiments, Wi-Fi operations within ZNIs may incorporate time-based adjustments into frequency-domain puncturing, to provide a dynamic response to both spatial and temporal aspects of potential interference. In such configurations, after defining the ZNIs, the SRE may receive the shared synchronization schedule from the UWB primary anchor 340, which details the timings and/or sequence for each UWB responding anchors 320 and 325 to transmit synchronization responses. Utilizing this information and the determined ZNIs, the SRE may determine when and where to implement specific RRM measures within the ZNIs. For example, if the schedule reveals that the UWB responding anchor 320 will respond to the synchronization message (from the UWB primary anchor 340) after a defined period (e.g., 10 microseconds) from receiving the message, the SRE may instruct AP 350 and STAs 310 and 315, within the ZNI of UWB responding anchor 320, to silence or reduce the power on certain Wi-Fi frequency bands that overlap with UWB transmissions or shift Wi-Fi traffic to alternative channels during the identified target window (e.g., 10 microseconds from receiving the synchronization message). Similarly, if the schedule reveals that the UWB responding anchor 325 will respond to the synchronization message (from the UWB primary anchor 340) after a defined period (e.g., 20 microseconds) from receiving the message, the SRE may instruct AP 355 and STAs 305 and 315, within the ZNI of UWB responding anchor 325, to adjust their Wi-Fi operations during the identified target window (e.g., 20 microseconds from receiving the synchronization message).

After implementing the adjustment within ZNIs, in some embodiments, the SRE may continuously monitor the effectiveness of these changes, which involves analyzing signal reports from APs and/or feedback from UWB anchors. For example, as the UWB primary anchor 340 reports on the success or failure of synchronization exchanges with UWB responding anchors 320 and 325, the SRE may use this information to adapt its RRM strategy. If the exchange was successful (indicating no or minimal interference) between UWB primary anchor 340 and UWB responding anchor 320, the SRE may instruct the AP 350 within the ZNI of UWB responding anchor 320 to reduce the extent of non-overlap for the next cycle. This may include allowing the AP 350 to schedule Wi-Fi signals over a larger overlapping segment with UWB channels than in the previous cycle. Through such adjustments, Wi-Fi bandwidth may be gradually increased without disrupting UWB operations. If the exchange failed between UWB primary anchor 340 and UWB responding anchor 320 (possibly due to interference), the SRE may instruct the AP 350 to increase the non-overlapping areas, such as scheduling Wi-Fi signals over a smaller overlapping segment with UWB channels. Such adjustments may increase the separation between the two technologies to improve the success rate of UWB synchronization. In some embodiments, the adjustment process may be iterative and continue until an equilibrium is reached. The equilibrium may refer to a status where anchor-to-anchor synchronization success in a ZNI is achieved with minimal impact on Wi-Fi segments. In some embodiments, the SRE may fine-tune the balance (e.g., the degree of overlap between Wi-Fi bands and UWB channels in use) based on real-time network performance data to ensure successful UWB communications and maintain efficient Wi-Fi operations.

In some embodiments, in addition to or instead of adjusting network operations to minimize interferences between UWB and Wi-Fi communications, techniques that enhance the inherent capabilities and robustness of UWB transmissions at the signal processing level may also be implemented. These techniques may help the UWB receivers (such as UWB anchors 320 and 325, or Wi-Fi devices with UWB capabilities) to effectively distinguish between overlapping signals, therefore further minimizing interference. One such technique involves increasing the length of the Synchronization Header (SHR) (e.g., 205 of FIG. 2B) in UWB packets. In some embodiments, the length adjustments may involve increasing the length of the preamble (e.g., 215 of FIG. 2B) and/or the repetitions of the SFD (e.g., 220 of FIG. 2B). The preamble includes a sequence of repetitive PSR used to help UWB receivers to synchronize with the incoming signals. By increasing the length of the preamble (which involves increasing the number of PSRs), more data for signal acquisition and timing estimation are provided, leading to improved ranging accuracy of the UWB system. The SFD is used to indicate the end of the SHR and the start of the data portion (e.g., 210 of FIG. 2B). A longer SFD may help UWB receivers in more accurately distinguishing the start of the actual data payload from the SHR. Increasing the repetitions of SFD may improve the reliability of frame detection and reduce the risk of frame misinterpretation.

While increasing the SHR length can enhance UWB signal detection, it also causes that more time spent in transmitting non-data symbols, which can reduce the overall data throughput of the system. Therefore, in some embodiments, the SHR length may be dynamically adjusted until a balance between improved accuracy and efficient data transmission using UWB technology is reached. The adjustment of the SHR length may depend on various factors, including, but not limited to, the specific requirements of the UWB system, the characteristics of the wireless environment (such as low or high density of Wi-Fi networks), the performance and reliability of the UWB communication under the given environmental conditions (e.g., SFD timeout, PHR error, data decoding error), and the design goal of the communication protocol being used. More detail is discussed above with reference to FIG. 2B.

In some embodiments, effectively distinguishing UWB signals from overlapping Wi-Fi signals may be achieved by dynamically adjusting the threshold for Channel Impulse Response (CIR) peak selection based on the density of the Wi-Fi environment. The threshold for CIR peak selection serves to differentiate between actual UWB signal peaks and random fluctuations due to noise or minor reflections. For example, in less congested Wi-Fi environments, the threshold may be reduced to enable the detection of weaker UWB signals. In contrast, in high-density Wi-Fi environments, increasing the threshold may help avoid false positives that may arise from noise. Advanced statistical methods may be used to define this threshold based on the characteristics of the wireless environment, the strength of the received UWB signals, and the noise level. In some embodiments, a dynamic filter (or threshold) for CIR peak selection may be established. In these configurations, the UWB receiver (e.g., UWB anchors 320 and 325, or Wi-Fi devices with UWB capabilities like STAs 305, 310 and 315) may first collect data on received UWB signals, and establish a CIR filter based on the initial conditions, such as setting the CIR filter to capture a certain percentage of the highest peak values (e.g., 10%). The filter established based on initial conditions (e.g., using the top 10% of highest peak values) may then be applied to identify and process UWB signals. The UWB receiver may continuously monitor the wireless environment for any significant changes, such as the airtime of Wi-Fi signals. As used herein, airtime refers to how much time Wi-Fi signals occupy the wireless medium. Variations in airtime may indicate changes in Wi-Fi traffic density, the presence of new Wi-Fi sources, or changes in Wi-Fi signal strength. If the system detects changes in the Wi-Fi environment (such as a significant increase or decrease in Wi-Fi airtime), it may indicate that the previous environmental conditions (based on which the initial CIR filter or threshold was set) have changed. In response to these detected changes, the UWB receiver may update the CIR filter to adapt to the new wireless environmental conditions. For example, if the Wi-Fi traffic has increased significantly, the UWB receiver (e.g., UWB anchors 320) may raise the threshold to avoid false positives caused by the increased Wi-Fi noise.

In some embodiments, such as when APs are integrated with UWB functions (e.g., UWB-enabled APs), these APs may manage the Wi-Fi network in a way that interference for UWB clients (e.g., UWB primary anchor 340, UWB tag 335) is reduced while still maintaining robust Wi-Fi capabilities. In some embodiments, the UWB-enabled AP (e.g., 325) may use the time-of-flight measurements, angle or arrival techniques, or other methods to determine the locations of UWB clients (like UWB primary anchor 340 and UWB tag 335). With the location information, the UWB-enabled AP 325 may then utilize beamforming techniques to shape its Wi-Fi signal's radiation pattern, resulting in a null 395 (an area of minimal Wi-Fi signal transmission) in the direction of the UWB devices. Within the null zone 395, Wi-Fi signals are effectively reduced, therefore avoiding interference with UWB operations.

In some embodiments, the UWB-enabled APs 325 (where AP 355 and UWB responding anchor 325 are integrated together) and 320 (where AP 350 and UWB responding anchor 320 are integrated together) may also manage the transmit power of Wi-Fi clients (e.g., STAs 305, 310, and 315) to further reduce potential interference with UWB signals. For example, the UWB-enabled AP 325 may misrepresent itself in a Low Power Idle (LPI) mode while it is actually in a Standard Power Idle (SPI) mode. In some embodiments, the power mode may be indicated in the beacon frames sent by UWB-enabled AP 325 to STAs 310 and 305. The STAs 310 and 305, with the belief that that the UWB-enabled AP 325 is operating in the LPI model, may adjust their transmission power (to align with the perceived power-saving mode of the AP) when communicating back to the UWB-enabled AP 325. In some embodiments, the UWB-enabled AP 325 may use trigger-based Multi-User (MU) uplink control to regulate the transmission power of STAs. The power adjustment in STAs may reduce the overall Wi-Fi signal power in the vicinity of the UWB-enabled AP 325, therefore mitigating interference with UWB devices operating in the same area.

In some embodiments, since the UWB-enabled AP (e.g., 325) has the advanced capability of handling both UWB and Wi-Fi signals, it may adjust the transmit power and channels for Wi-Fi usage based on the active UWB channels. For example, if the UWB system is operating on channel 6, the UWB-enabled AP 325 may allocate channels in the UNII-5 band for Wi-Fi, as its frequency range does not overlap (or minimally overlaps) with that of UWB channel 6 (as depicted in FIG. 2B).

Although the illustrated network infrastructure 300 depicts the UWB anchor 320 and the AP 350 as two separate components, as well as the UWB anchor 325 and the AP 355 as two separate components, the illustrated network infrastructure 300 is only provided for conceptual clarity. In some embodiments, the UWB anchor and the AP in each pair may be co-located. For example, the UWB anchor 320 and the AP 350 may be co-located in that the Wi-Fi and UWB signals within their coverage areas 375 and 380 are transmitted and/or received by a single device. Similarly, the UWB anchor 325 and the AP 355 may be co-located in that the Wi-Fi and UWB signals within their coverage areas 385 and 390 are transmitted and/or received by a single device.

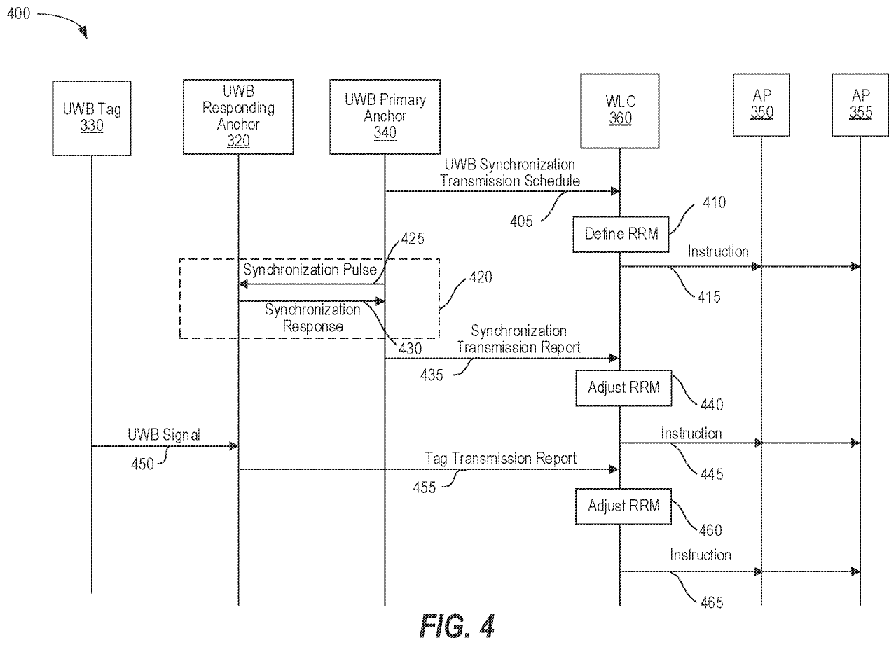

FIG. 4 depicts a sequence 400 for UWB anchor synchronization and dynamic radio resource management (RRM), according to some embodiments of the present disclosure.

In the illustrated example, the UWB primary anchor 340 may initiate the synchronization process by sending synchronization pulses to two UWB responding anchors 320 and 325 (as depicted in FIG. 3). The SRE functions are integrated into the WLC 360, which oversees the operations of both AP 350 and AP 355, and manages resource allocation and scheduling between Wi-Fi devices (such as APs 350 and 355) and UWB devices (like UWB responding anchor 320, UWB primary anchor 340, and UWB tag 330). As illustrated, the UWB primary anchor 340 may first share UWB synchronization transmission schedule 405 with the WLC 360. The schedule may include the timings and/or sequence for each responding anchor (e.g., 320 or 325) to send back synchronization responses to the UWB primary anchor 340. Based on the received transmission schedule, the WLC 360 defines RRM strategies to manage Wi-Fi frequencies, power levels, or transmission time windows to minimize interference with UWB communications (as depicted by block 410), and transmits corresponding instructions 415 to APs 350 and 355. For example, if the WLC 360 determines that the UWB message will be transmitted on UWB channel 5, the instructions may direct APs 350 and 355 to avoid using any Wi-Fi channels that overlap with channel 5 entirely. In embodiments where complete avoidance is not applicable, the WLC 360 may instruct the APs 350 and 355 to select Wi-Fi channels where the primary 20 MHz bandwidth is centered on a frequency falling outside of the UWB channel 5 (from 6240 MHZ to 6740 MHz), with only the extension parts of the Wi-Fi channels overlapping (such as Wi-Fi sub-channels like 47 and 55 as depicted in FIG. 2A).

In the illustrated example, the UWB primary anchor 340 initiates a cycle 420 of the synchronization process with UWB responding anchors 320 and 325. Within the cycle 420, the UWB primary anchor 340 transmits a synchronization pulse 425 to both the UWB responding anchors 320 and 325. Each UWB responding anchor, like the anchor 320 as depicted, sends a synchronization response 430 back to the primary anchor 340 at its allocated time slot (defined in the synchronization schedule). Once the primary anchor 340 receives the synchronization response 430, it evaluates the success of the first cycle of synchronization exchange (e.g., whether the response was received within the expected time frame). The primary anchor 340 then reports the results of the synchronization attempt 435 to the WLC 360.

In the illustrated example, based on the results reported by the primary anchor 340, the WLC 360 may make further adjustments 440 to the RRM strategies and send corresponding instructions 445 to APs 350 and 355. For example, if the synchronization exchange was successful, the WLC may instruct APs 350 and 355 to reduce the extent of non-overlap for Wi-Fi channels in the next cycle. If the exchange was unsuccessful, either between the primary anchor 340 and the responding anchor 320, or between the primary anchor 340 and responding anchor 325, or both (possibly due to interference or timing issues), the WLC 360 may decide to increase the extent of non-overlap for Wi-Fi channels in the next synchronization cycle.

As illustrated, when a UWB tag 330 enters the signal coverage area of the UWB responding anchor 320, the anchor 320 can detect the signal 450 sent by the tag 330. The detection allows the anchor 320 to determine the presence and/or location of the tag 330 (e.g., based on the signal's strength or time of arrival). Upon detecting the UWB tag 330, the UWB responding anchor 320 reports the event to WLC 360, alerting it of the current active UWB tag transmission and/or the possibility of future tag transmissions between the tag 330 and anchor 320 (as indicated by arrow 455) at unpredictable intervals. In response to the notification from anchor 320, the WLC 360 may decide to further adjust the RRM strategies to mitigate potential interference with the UWB tag transmissions (as indicated by block 460). For example, the WLC 360 may instruct APs 350 and 355 (as indicated by arrow 465) to further increase the extent of non-overlap for Wi-Fi channels to create a larger buffer zone between the frequencies used by UWB devices and those used by Wi-Fi devices. In some embodiments, the WLC 360 may instruct APs 350 and 355 to adjust Wi-Fi channel usage based on time, scheduling Wi-Fi activities (e.g., Wi-Fi TXOPs or RUs) during periods when UWB activities are expected to be low or inactive. In some embodiments, the WLC 360 may instruct APs 350 and 355 to reduce the power level of Wi-Fi transmissions to reduce the likelihood of interference when UWB tags are transmitting.

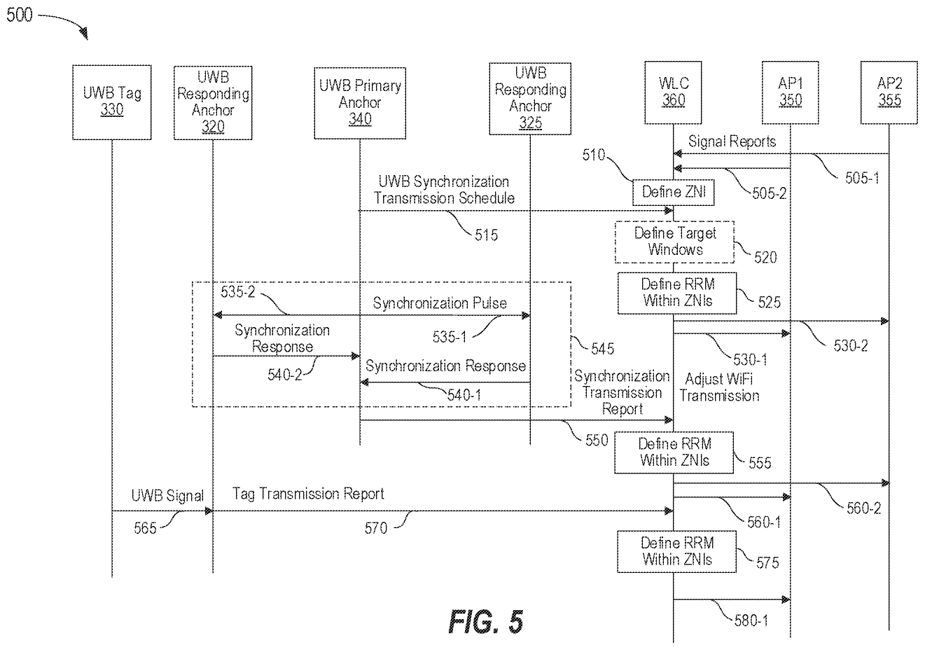

FIG. 5 depicts a sequence 500 for zone-of-non-interference-based (ZNI-based) dynamic radio resource management (RRM), according to some embodiments of the present disclosure.

In the illustrated example, the UWB primary anchor 340 may initiate the synchronization process by sending synchronization pulses to two UWB responding anchors 320 and 325. The SRE functions are integrated into the WLC 360, which oversees the operations of both APs 350 and 355, and manages resource allocation and scheduling between Wi-Fi devices (such as APs 350 and 355) and UWB devices (such as UWB responding anchors 320 and 325, UWB primary anchor 340, and UWB tag 330). As illustrated, each AP (e.g., AP 350, AP 355) continuously monitors the radio frequency (RF) environment within its operational range. The monitoring process may involve detecting and measuring the strength (e.g., RSSI, SNR) of signals sent from other APs, clients of these APs, and/or UWB anchors within the AP's operational range. For example, AP 350 may detect and measure the strength (e.g., RSSI, SNR) of signals sent by UWB responding anchor 320, and STAs 310 and 315, as these devices fall within its coverage zone 375 (as depicted in FIG. 3). Similarly, AP 355 may detect a wide range of signals from UWB responding anchor 325, and STAs 305 and 315, and measure the corresponding signal strength (e.g., RSSI, SNR). Following the continuous monitoring, as illustrated, the APs 350 and 355 generate signal reports 505, and/or transmit these reports to the WLC 360. The signal reports 505 may include information such as detected signal strengths and frequencies being used, the duration and time of detected transmissions, potential sources of the signals (if identifiable), and/or any observed patterns or changes in the RF environment, among others.

In some embodiments, upon receiving the signal reports 505, the WLC 360 may aggregate the signal data transmitted by different APs (including the detected signal strengths within their zones of detection), and determine the active UWB transmissions in the vicinity of the APs. In some embodiments, the signal strengths may indicate the presence or location of a device. For example, the areas where UWB signals are consistently strong may be identified as the probable locations of the UWB anchors. In some embodiments, the WLC 360 may use algorithms and/or mapping techniques to identify the precise locations of UWB anchors accurately within the RF environment.

Based on the identified locations of UWB anchors, as illustrated, the WLC 360 defines ZNIs around each UWB anchor ((s indicated by block 510). As used herein, a ZNI refers to a physical zone where UWB transmissions are given priority to ensure efficient operation. Within these zones, interference from other RF sources like Wi-Fi signals is minimized to prevent disruptions of UWB transmissions. The size and shape of a ZNI may depend on the strength and range of UWB signals and the layout of the RF environment. In some embodiments, the ZNI for a UWB anchor may align with its signal coverage. For example, ZNI for UWB responding anchor 320 may align with its signal coverage 380 (which includes AP 350, and STAs 310 and 315), and ZNI for UWB responding anchor 325 may align with its signal coverage 390 (which includes AP 355, and STAs 305 and 315).

In the illustrated example, the UWB synchronization transmission schedule 515 is shared by the UWB primary anchor 340 with the WLC 360. Based on the define ZNIs 510 and/or the synchronization schedule 515, the WLC 360 may adapt Wi-Fi transmissions to respect UWB priority within these ZNIs to mitigate interference with UWB signals (as indicated by block 525). The adjustment may include instructing all Wi-Fi APs within a specific ZNI to avoid using certain channels that overlap with UWB frequencies, or allowing some APs within the ZNI to use certain overlapping frequencies with reduced power. For example, if the UWB primary anchor is sending a synchronization message to the responding anchors 320 and 325 using UWB channel 5 (assuming ZNIs are established around anchors 320 and 325), the WLC 360 may instruct all APs and STAs within these two ZNIs to avoid using any segment of Wi-Fi channels overlapping with UWB channel 5. In embodiments where completely avoiding channel 5 is not applicable, the WLC 360 may direct AP 350 and its associated STAs 310 and 315 (as depicted in FIG. 3) (within the ZNI of UWB responding anchor 320) to use a frequency band that partially overlaps with UWB channel 5 (e.g., choosing frequency band where the primary 20 MHz band avoids channel 5), and maintain AP 355 and its associated STA 305 (as depicted in FIG. 3) (with the ZNI of UWB responding anchor 325) completely avoid channel 5. In such configurations, different instructions 530-1 and 530-2 are transmitted to AP 350 and AP 355, respectively. In some embodiments, the WLC 360 may implement dynamic channel selection for Wi-Fi APs to adapt to changing RF conditions. For example, if the UWB communication pattern changes and channel 5 is no longer used by UWB responding anchor 325 (e.g., UWB operations are transferred to channel 6), the WLC 360 may adaptively allow AP 355 and its associated STA 305 (with the ZNI of UWB responding anchor 325) to resume normal operations on segments that overlap with UWB channel 5 (e.g., by sending the instruction 530-2).

As discussed above, the shared synchronization schedule 515 indicates the timings and/or sequence for each responding anchor to send back a response 540 to the UWB primary anchor. In some embodiments, based on the shared schedule 515, the WLC 360 may determine target windows for UWB transmissions, and optionally incorporate the time-based adjustments into channel selection (as depicted by block 520). For example, if the schedule 515 indicates the UWB responding anchor 320 is set to wait a defined period, like 20 microseconds, before sending a synchronization response to the primary UWB anchor 340 on UWB channel 5 after a specific event (e.g., receiving the synchronization pulse 535), the AP 350 and STAs 305 and 315 within the ZNI of anchor 320 may operate normally, using frequency bands that overlap with UWB channel 5 during the 20-microsecond waiting period. When the 20-microsecond waiting period ends and anchor 320 begins transmitting its response 540-2, the AP 350 and STAs 305 and 315 within the ZNI may silence their Wi-Fi transmissions on the overlapping frequency bands, reserving the overlapping bands for UWB transmissions only. Once the transmission from UWB anchor 320 is complete, the AP 350 and STAs 305 and 315 may resume normal operations on the previously silenced frequency bands. To avoid conflicts with anchor 320, anchor 325 may be instructed to wait 40 microseconds after receiving the synchronization pulse 535-1 to send its response 540-1. Wi-Fi transmissions in the ZNI for anchor 325 may remain normal during the 40-microsecond waiting period, and silence on the overlapping frequency bands with UWB channel 5 as the waiting period ends and the anchor 325 begins its response transmission. After anchor 325 completes its transmissions, the AP 355 and its associated STAs resume their Wi-Fi activities on the previously silenced frequency bands. These instructions 530-1 and 530-2 for Wi-Fi devices within different ZNIs may be dynamically adjusted based on the real-time synchronization schedule 515 of the UWB system. In some embodiments, the WLC 360 may continuously monitor the UWB and WiFi activities within the ZNIs to ensure that the Wi-Fi network adapts to the changing UWB transmission schedule.

In the illustrated example, following the implementation of the ZNI-based RRM strategies, the UWB primary anchor 340 begins the first synchronization cycle 545 by transmitting a synchronization pulse 535 to both responding anchors 320 and 325. The pulse serves as a reference point for timing their responses. Each UWB responding anchor, following its allocated timing and sequence, sends back its respective synchronization response 540-1 or 540-2 to the primary anchor 340. The Wi-Fi APs and STAs within each ZNI are managed respectively, to ensure the Wi-Fi transmissions within each ZNI do not conflict with the anchor's response windows. Once the synchronization exchange 545 is complete, the primary anchor 340 then reports the results of the synchronization to the WLC 360. Based on the results, the WLC 360 may make further adjustments to the Wi-Fi operations within each ZNI (as indicated by block 555). For example, if the report indicates that the synchronization exchange between the primary anchor 340 and the responding anchor 320 was successful but the exchange between anchors 340 and 325 was unsuccessful (possible due to interference or timing issues), the SRE may instruct AP 350 and its associated STAs (which are in the ZNI around anchor 320) to reduce the non-overlap segment for its Wi-Fi transmissions (as indicated by arrow 560-1), whereas the SRE may instruct AP 355 and its associated STAs (which are in the ZNI around anchor 325) to increase the non-overlap segment for its Wi-Fi transmissions (as indicated by arrow 560-2). As used herein, reducing the non-overlap segment refers to a situation where a Wi-Fi device (e.g., AP 350) is allowed to use a broader portion of the Wi-Fi channel that partially overlaps with the UWB frequency band (e.g., UWB channel 5). As used herein, increasing the non-overlap segment means that Wi-Fi device (e.g., AP 355) is configured to use a smaller portion of its Wi-Fi channel to ensure there is less overlap with the UWB frequency band. The adjustment is used to reduce the risk of interference with UWB communications. With the report 550, the WLC 360 may dynamically adjust its RRM strategies within each ZNI based on the synchronization outcomes. In some embodiments, the adjustment process may be repeated multiple times until an equilibrium is reached, where anchor-to-anchor synchronizations succeed in each ZNI with minimized impacts on Wi-Fi communications.

In embodiments where a UWB network is used for services like asset tracking, communication between UWB tags and UWB anchors may occur. These tags may be integrated into various objects (e.g., smartphone 110, shopping cart 105 of FIG. 1) to track movements or locations. In the illustrated example, the UWB responding anchor 320 detects the signal 565 transmitted by the UWB tag 330 as it enters the detection range of the anchor 320. The detection allows the anchor 320 to determine the presence and/or location of the tag 330 within its range. Upon detecting the UWB tag 330, the anchor 320 reports the presence of tag 330 to the WLC 360 (as depicted by arrow 570). The report may indicate the estimated location of the tag 330, and/or the possibility for future tag transmissions at unpredictable intervals. The WLC 360 then analyzes the potential impact within the ZNI around anchor 320, such as the affected Wi-Fi devices (e.g., AP 350, STA 310, STA 315), and determines whether additional adjustments are needed to mitigate potential interference with UWB tag transmissions (as indicated by block 575). For example, if the AP 350 and its associated STAs were previously allowed to use Wi-Fi channels (e.g., Wi-Fi sub-channels 47 and 55 of FIG. 2B) that partially overlap with UWB channel 5, in response to an increase in UWB tag transmissions (like a large number of UWB-tagged shopping carts 105 in the area), the WLC 360 may instruct the affected AP 350 and its associated STAs to switch their operations to alternative channels (e.g., Wi-Fi sub-channels 15, 175, and 207 of FIG. 2B) that avoids UWB channel 5 entirely (as indicated by arrow 580-1).

The ZNI-based RRM defines specific spatial zones around UWB anchors. By defining ZNIs, the SRE may manage radio resource allocation adaptively in response to changes within these specific areas. The ZNI-based RRM also allows for more customized management of Wi-Fi operations based on their proximity to UWB anchors, where only APs and STAs within the ZNI of a UWB anchor need to adjust their Wi-Fi operations, whereas these outside the ZNIs can operate normally. This method offers more precise and area-specific radio resource coordination to optimize UWB transmissions, with reduced disruption to the broader Wi-Fi network.

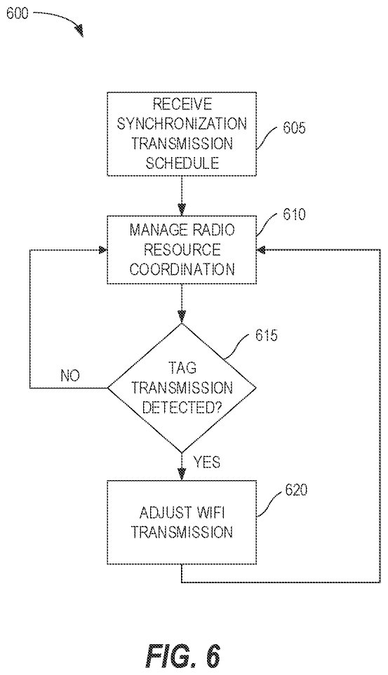

FIG. 6 depicts an example method 600 for adjusting Wi-Fi transmission based on a shared UWB synchronization schedule, according to some embodiments of the present disclosure. In some embodiments, the method 600 may be performed by an AP, such as the AP 120 of FIG. 1, the APs 350 and 355 of FIGS. 3, 4, and 5, and/or a WLC, such as the WLC 360 of FIGS. 3, 4, and 5.

The method 600 begins at block 605, where an AP (or a WLC) receives the synchronization transmission schedule from a UWB system (e.g., from a UWB primary anchor 340 of FIG. 3). In embodiments where the UWB system includes multiple responding anchors, the schedule may include information such as the timings and/or sequence in which responding anchors are expected to communicate for time synchronization, the duration of each anchor's transmission, and the specific frequencies or channels on which the UWB system operates. The AP may use the schedule to evaluate how Wi-Fi network may impact the UWB transmissions, and what adjustments can be made to mitigate potential interference. In some embodiments, the schedule may be integrated into the RRM system where relevant strategies for resource allocation are defined and implemented to mitigate interference and ensure efficient operation of both UWB and Wi-Fi systems.

At block 610, based on the shared schedule, the AP (or the WLC) actively manages the allocation of radio resources for the coexistence of UWB and Wi-Fi systems. In some embodiments, the AP may assess the Wi-Fi channel landscape and determine whether to avoid using certain Wi-Fi channels. For example, as discussed above, this may include shifting Wi-Fi traffic away from channels that overlap with UWB frequencies, or selecting Wi-Fi channels where the primary 20 MHz bandwidth does not overlap with the frequencies used by UWB systems (with only the extension band overlapping with UWB frequencies), which allows some level of coexistence provided that the Wi-Fi network does not interfere with UWB communications. In some embodiments, the AP (or the WLC) may implement scheduling strategies for Wi-Fi transmissions. For example, based on the shared UWB synchronization schedule, the AP may allocate specific time windows (e.g., TXOPs or RU) for Wi-Fi activities to avoid overlapping with scheduled UWB transmissions.

At block 615, the AP (or the WLC) monitors the network to detect any UWB tag transmissions. As used herein, tag transmission refers to the process of a UWB tag transmitting data to a UWB anchor when it enters the anchor's signal range. The transmitted data may include identification information about the tag, timestamps, and possibly sensor data (if the tag is configured with sensors) (e.g., temperature, motion). When a UWB tag enters the signal range of a UWB anchor, the anchor may detect the signal broadcasted by the tag, and use it to calculate the tag's location. In environments where UWB systems coexist with Wi-Fi systems, the detection of tag transmission may be communicated by the UWB anchor to its nearest Wi-Fi AP, informing the Wi-Fi network about the current active UWB tag transmission and/or potential future tag transmissions (at unpredictable intervals). If a tag transmission is detected, indicating active tag transmission nearby, the method 600 proceeds to block 620, where AP (or the WLC) determines whether additional adjustments for the Wi-Fi operations are preferred to mitigate potential interference with the UWB tag transmissions. In some embodiments, the AP (or the WLC) may further change Wi-Fi channels, such as by increasing the non-overlapping segment with UWB frequency bands. For example, if Wi-Fi traffic is using frequencies that partially overlap with UWB channel 5, the AP (or the WLC) may shift to a channel where there is no overlap with channel 5. In some embodiments, the AP (or the WLC) may schedule Wi-Fi activities for times when UWB activities are expected to be low or absent. In some embodiments, the AP (or the WLC) may reduce the power level of Wi-Fi transmission to minimize the potential for interference with nearby UWB devices. If no tag transmission is detected, the method 600 returns to block B, where the AP (or the WLC) continuously monitors the network environments (e.g., Wi-Fi or UWB signal strengths, channel usage, interference patterns), and optimizes the radio resource coordination for Wi-Fi and UWB systems.

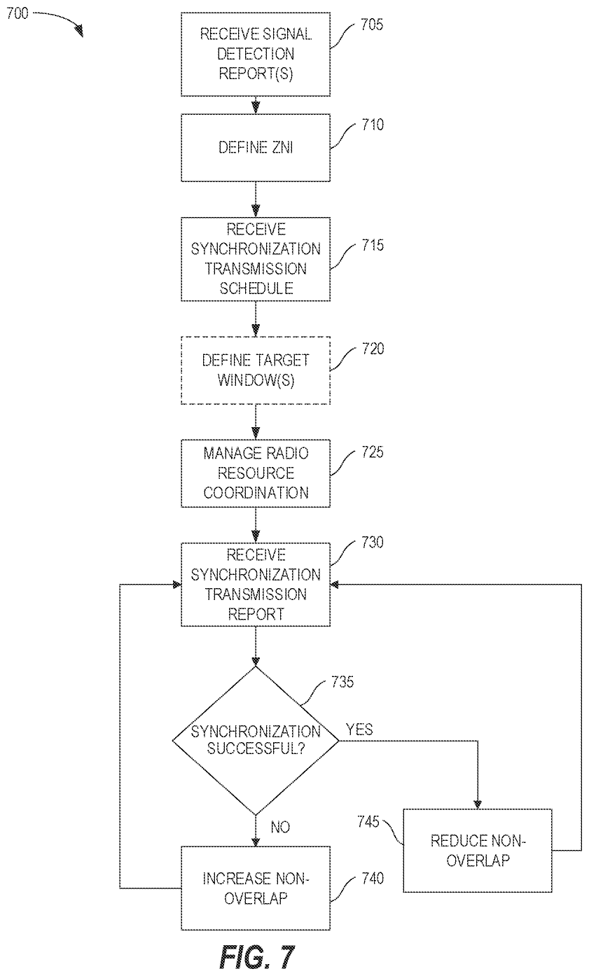

FIG. 7 depicts an example method 700 for frequency-domain puncturing based on defined ZNIs and a shared UWB synchronization schedule, according to some embodiments of the present disclosure. In some embodiments, the method 700 may be performed by an AP, such as the AP 120 of FIG. 1, the APs 350 and 355 of FIGS. 3, 4, and 5, and/or a WLC, such as the WLC 360 of FIGS. 3, 4, and 5.

At block 705, an AP (or the WLC) receives signal reports from its connected APs within the same network. The report may include information about the APs' nearby RF environments, such as the strengths of Wi-Fi or UWB signals, the active channel used by Wi-Fi or UWB systems, or any potential source of interference or noise. Based on the reports, the AP (or the WLC) may perform an initial assessment of the overall RF environment, including identifying the locations of the UWB anchors based on the detected UWB signals and their strength (e.g., RSSI, SNR). The areas where UWB signals are consistently strong are likely to be in close proximity to UWB anchors. By analyzing the strength and distribution of UWB signals across different areas, the AP (or the WLC) may map out the probable locations of the UWB anchors.

At block 710, the AP (or the WLC) uses the information within the signal reports (e.g., the mapped locations of UWB anchors and their proximity to Wi-Fi devices) to define ZNIs around the UWB anchors. Within the ZNIs, UWB transmissions are prioritized, and interference from other sources, like Wi-Fi, is minimized. For example, in some embodiments, Wi-Fi channels that overlap with UWB frequencies may be avoided within these ZNIs, or the power levels of Wi-Fi devices within these ZNIs may be reduced to minimize interference. In some embodiments, specific time windows may be allocated to Wi-Fi traffic, where the allocated Wi-Fi time windows avoid conflicts with the scheduled UWB transmissions. In some embodiments, the ZNIs may be dynamically adjusted depending on the changes in the RF environment and/or the requirements of the UWB system.

At block 715, the AP (or the WLC) receives a detailed synchronization transmission schedule from the UWB system (e.g., from the UWB primary anchor 340 of FIG. 3). The schedule provides information on the sequence and timings of UWB transmissions (e.g., for each UWB responding anchor to send synchronization responses to the UWB primary anchor).

At block 720, based on the synchronization schedule, the AP (or the WLC) may define target windows for UWB transmissions within each ZNI. The target windows may refer to periods during which anchor-to-anchor synchronizations within the ZNI occur (e.g., the UWB responding anchor transmits a response to the UWB primary anchor for time synchronization). During these target windows, the AP (or the WLC) may silence or significantly reduce Wi-Fi transmissions on frequencies that overlap with UWB transmissions to minimize Wi-Fi interferences within the ZNIs. Outside the ZNIs and the target windows, Wi-Fi devices may operate normally with minimal or no changes.

The process at block 720 is optional (as indicated by the dashed line), and is designed to minimize the impact on overall Wi-Fi network performance by confining adjustments both spatially (within defined ZNIs) and temporally (within specific target windows designated for each ZNI). The spatial adjustments may ensure that the changes to Wi-Fi operations are localized to areas where UWB activity is concentrated, and therefore reduce unnecessary disruption in areas outside the ZINs. The temporal adjustments align these Wi-Fi changes to specific time periods (target windows) when UWB activity is scheduled, reducing the duration of the impact on Wi-Fi networks.

At block 725, the AP (or the WLC) manages the radio resources within ZNIs for the coexistence of UWB and Wi-Fi systems. For example, in embodiments where the schedule indicates that a UWB anchor (e.g., 320 of FIG. 3) participates in time synchronization (e.g., receiving a synchronization pulse from the primary anchor), the AP (or the WLC) may examine the ZNI for the UWB anchor, and instruct Wi-Fi devices (e.g., AP 350, STA 310, and STA 315 of FIG. 3) within the ZNI to avoid using channels that overlap with UWB frequencies. In embodiments where total avoidance of overlapping Wi-Fi channels is not feasible or preferred, the AP (or the WLC) may allow some Wi-Fi devices within the ZNI to use certain overlapping frequencies (with reduced transmission power), provided that the Wi-Fi network does not disrupt the UWB transmissions. In some embodiments, based on the determined target windows for UWB transmissions, the AP (or the WLC) may incorporate time-based adjustments into Wi-Fi channel selection within ZNIs. For example, if a target window for UWB transmission from a UWB anchor (e.g., 320 of FIG. 3) is determined, Wi-Fi devices (e.g., AP 350, STA 310, and STA 315 of FIG. 3) within the ZNI of the anchor may be guided to either silence Wi-Fi traffic during the target window, or shift Wi-Fi traffic away from the overlapping frequencies during the target window.

At block 730, the AP (or the WLC) receives a report from the UWB system (e.g., the UWB primary anchor 340 of FIG. 3). The report may indicate whether the synchronization exchange between the primary anchor (e.g., 340 of FIG. 3) and each of the responding anchors (e.g., 320 and 325 of FIG. 3) was successful. Based on the report's findings, the AP (or the WLC) may make further adjustments to the Wi-Fi network within each ZNI.

At block 735, the AP (or the WLC) determines whether a synchronization exchange between the primary anchor (e.g., 340 of FIG. 3) and the responding anchor (e.g., 320 FIG. 3) was successful. Success in synchronization exchange may refer to a situation where the responding anchor receives the pulse message from the primary anchor and sends a response message back, which is received by the primary anchor within a defined time frame. If the synchronization exchange was successful, the method 700 proceeds to block 745, where the AP (or the WLC) determines to reduce the non-overlapping segment of Wi-Fi channels with UWB frequencies. This reduction may allow Wi-Fi transmissions within the ZNI of the anchor to use a broader range of frequencies, potentially increasing the available Wi-Fi bandwidth. If the synchronization exchange was not successful, it suggests potential interference between Wi-Fi and UWB systems. In such configurations, the method 700 moves to block 740, where the AP (or WLC) chooses to increase the non-overlapping segment. Within the ZNI of the anchor, Wi-Fi devices may use a smaller overlapping segment for communications. While such adjustments may constrain Wi-Fi bandwidth, they can effectively increase the buffer between Wi-Fi and UWB frequencies, therefore mitigating interference and improving UWB synchronization success rate. The AP (or the WLC) may continue to monitor the synchronization exchanges between UWB anchors, and dynamically adjust Wi-Fi channels within ZNIs in response to the changing conditions in the RF environment. In some embodiments, the adjustment process may be iterative and continue until an equilibrium is reached within the ZNI (where anchor-to-anchor synchronization success is achieved with minimal impact on the Wi-Fi network).

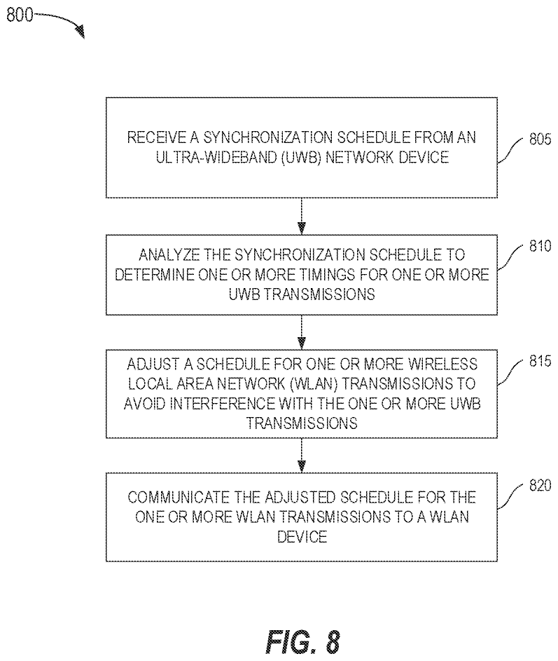

FIG. 8 is a flow diagram depicting an example method 800 for optimizing the coexistence of ultra-wideband (UWB) and Wi-Fi transmissions, according to some embodiments of the present disclosure.

At block 805, a network device (e.g., AP 350, AP 355, or WLC 360 of FIG. 3) receives a synchronization schedule (e.g., 405 of FIG. 4, or 515 of FIG. 5) from an ultra-wideband (UWB) network device (e.g., UWB anchor 340 of FIG. 3). In some embodiments, the UWB network device may comprise a UWB anchor.

At block 810, the network device analyzes the synchronization schedule to determine one or more timings for one or more UWB transmissions. In some embodiments, the synchronization schedule may indicate one or more expected timings for transmitting one or more synchronization messages by the UWB network device.

At block 815, the network device adjusts a schedule for one or more Wireless Local Area Network (WLAN) transmissions based on the radio resources allocated for the one or more UWB transmissions (as depicted by block 410 of FIG. 4). In some embodiments, adjusting the schedule for the one or more WLAN transmissions may include allocating the one or more WLAN transmissions to one or more frequency bands, channels, TXOPs, or RUs to avoid overlaps with the one or more UWB transmissions.

At block 820, the network device communicates the adjusted schedule for the one or more WLAN transmissions to a WLAN device (e.g., AP 350, or AP 355 of FIG. 3) (as depicted by arrow 415 of FIG. 4). In some embodiments, the network device may further receive a notification (e.g., 455 of FIG. 4), from the UWB network device (e.g., UWB anchor 320 of FIG. 4), indicating a UWB tag transmission, and adjust the schedule for the one or more WLAN transmissions to avoid interference with the UWB tag transmission (as depicted by block 460 of FIG. 4).

In some embodiments, the network device may further establish a Zone of Non-Interference (ZNI), where within the ZNI, one or more frequency bands are exclusively reserved for the one or more UWB transmissions (as depicted by block 525 of FIG. 5). In some embodiments, the network device may further determine one or more time windows based on the received synchronization schedule from the UWB network device (as depicted by block 520 of FIG. 5), and establish a Zone of Non-Interference (ZNI), where within the ZNI, one or more frequency bands are exclusively reserved for the one or more UWB transmissions during the one or more time windows (as depicted by block 525 of FIG. 5).

In some embodiments, the UWB network device (e.g., UWB anchor 340 of FIG. 3), before initiating the one or more UWB transmissions, may increase a frame length of a UWB message based on one or more physical layer metrics. In some embodiments, the UWB network device may dynamically adjust a threshold for CIR peak selection based on a density of the one or more WLAN transmissions in an environment.

In some embodiments, the WLAN device (e.g., AP 350, or AP 355 of FIG. 3) may receive a message indicating a location of the UWB device, and nullify the one or more WLAN transmissions towards the location of the UWB device using beamforming techniques.

In some embodiments, the WLAN device may comprise an Access Point (AP) (e.g., AP 350, or AP 355 of FIG. 3), and the AP may transmit a message to an associated client device (e.g., STA 305, STA 310, or STA 315 of FIG. 3) indicating that the AP is in Low Power Idle (LPI) mode while the AP is actually in Stay-Put Idle (SPI) mode. In some embodiments, the associated client device, after receiving the message, may communicate with the AP using a reduced transmission power.

In some embodiments, the WLAN device may comprise an Access Point (AP) (e.g., AP 350, or AP 355 of FIG. 3), and the AP may reallocate the one or more WLAN transmissions to a second channel that does not overlap with a first channel used for the one or more UWB transmissions.

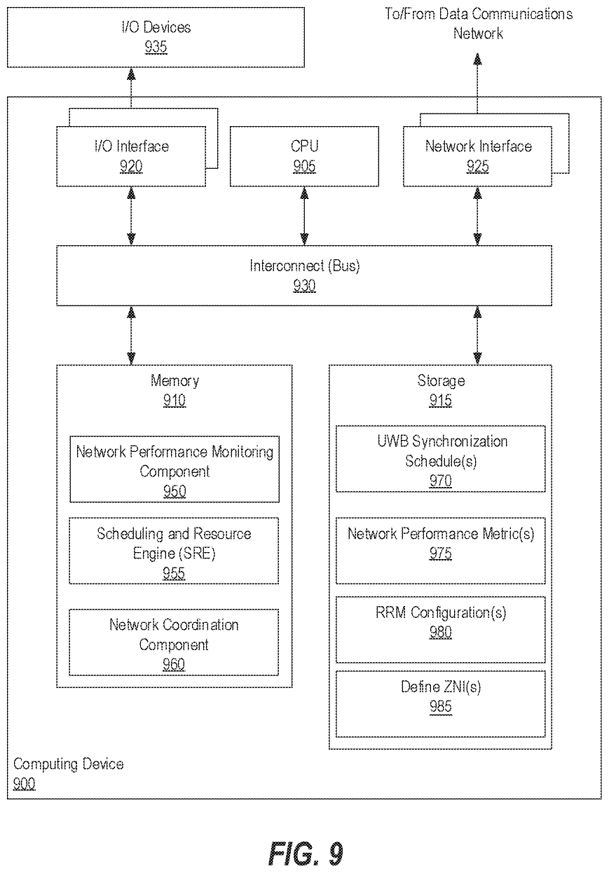

FIG. 9 depicts an example computing device 900 configured to perform various aspects of the present disclosure, according to one embodiment. Although depicted as a physical device, in embodiments, the computing device 900 may be implemented using virtual device(s), and/or across a number of devices (e.g., in a cloud environment). In one embodiment, the computing device 900 may correspond to an AP, such as the AP 120 of FIG. 1, or the APs 350 or 355 of FIGS. 3, 4, and 5. In one embodiment, the computing device 900 may correspond to a WLC, such as the WLC 360 of FIGS. 3, 4, and 5.

As illustrated, the computing device 900 includes a CPU 905, memory 910, storage 915, one or more network interfaces 925, and one or more I/O interfaces 920. In the illustrated computing device, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally included to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930. In some embodiments, the computing device 900 may include one or more antennas and one or more RF transceivers.

In the illustrated computing device, the memory 910 includes a network performance monitoring component 950, a scheduling and resource engine (SRE) 955, and a network coordination component 960. Although depicted as a discrete component for conceptual clarity, in some aspects, the operations of the depicted component (and others not illustrated) may be combined or distributed across any number of components. Further, although depicted as software residing in memory 910, in some aspects, the operations of the depicted components (and others not illustrated) may be implemented using hardware, software, or a combination of hardware and software.

In one embodiment, the network performance monitoring component 950 may scan and measure the strength (e.g., RSSI) of nearby Wi-Fi and/or UWB signals transmitted to or from APs, non-AP devices, UWB anchors, or UWB tags in its vicinity. The component 950 may perform channel utilization analysis to identify the channels or frequency bands being used by either the Wi-Fi or UWB systems. The component 950 may report the collected data about the nearby RF environment to the SRE 955 for effective management and coordination of radio resources to ensure the coexistence of UWB and Wi-Fi systems.

In one embodiment, the SRE 955 may develop and implement RRM strategies for optimally managing radio resources. The SRE 955 may understand the nearby RF environment and UWB transmission demands based on the signal data collected by the network performance monitoring component 950 and/or the synchronization schedules shared by the UWB system. Based on the analysis of the RF environment and the UWB schedules, the SRE 955 may adjust Wi-Fi operations to mitigate potential interference. For example, in some embodiments, the SRE 955 may redirect Wi-Fi traffic completely away from frequency segments overlapping with UWB transmissions, or choose Wi-Fi segments that only partially overlap with UWB frequencies when complete avoidance is not feasible. In some embodiments, the SRE 955 may schedule Wi-Fi activities during times that do not overlap with UWB transmission windows to avoid conflicts. In some embodiments, the SRE 955 may establish ZNI for each UWB anchor. Within each ZNI, the SRE 955 may implement specific adjustments to Wi-Fi operations based on each anchor's UWB transmission schedule and the unique characteristics of the zone.

In embodiments where the computing device 900 are configured with UWB capacities, the computing device may further manage Wi-Fi networks to mitigate interference through the network coordination component 960. For example, when the locations of UWB devices are determined (e.g., based on the time-of-flight measurements), the network coordination component 960 may use beamforming techniques to create a null zone (e.g., 390 of FIG. 3) in the direction of the UWB devices. In some embodiments, the network coordination component 960 may reduce the transmit power of Wi-Fi client devices to further reduce potential interference with UWB signals. For example, the network coordination component 960 may induce a STA's response in reduced transmit power (e.g., reduced by 6 dB) by communicating to the STA (through beacon frames) that the computing device 900 is in LPI model (while it is actually in SPI mode).

In the illustrated example, the storage 915 include shared UWB synchronization schedule 970 (including timing information for synchronization pulses and responses), the collected network performance metrics 975 (e.g., signal strengths, error rate, throughput), the RRM configurations 980 (including the current channel assignments for Wi-Fi and UWB systems), and the defined ZNIs 985 (including information about which APs and clients are within each ZNI). Although depicted as residing in storage 915, the aforementioned data may be stored in any suitable location, such as a remote database.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving a synchronization schedule from an Ultra-wideband (UWB) network device;
analyzing the synchronization schedule to determine one or more timings for one or more UWB transmissions;
adjusting a schedule for one or more Wireless Local Area Network (WLAN) transmissions to avoid interference with the one or more UWB transmissions; and
communicating the adjusted schedule for the one or more WLAN transmissions to a WLAN device.

2. The method of claim 1, wherein the UWB network device comprises a UWB anchor.

3. The method of claim 1, wherein the synchronization schedule indicates one or more expected timings for transmitting one or more synchronization messages by the UWB network device.

4. The method of claim 1, wherein adjusting the schedule for the one or more WLAN transmissions includes allocating the one or more WLAN transmissions to one or more frequency bands, channels, transmission opportunities (TXOPs), or resource units (RUs) to avoid overlaps with the one or more UWB transmissions.

5. The method of claim 1, further comprising:
receiving a notification, from the UWB network device, indicating a UWB tag transmission; and
adjusting the schedule for the one or more WLAN transmissions to avoid interference with the UWB tag transmission.

6. The method of claim 1, further comprising establishing a Zone of Non-Interference (ZNI), wherein within the ZNI, one or more frequency bands are exclusively reserved for the one or more UWB transmissions.

7. The method of claim 1, further comprising:
determining one or more time windows based on the received synchronization schedule from the UWB network device; and
establishing a Zone of Non-Interference (ZNI), wherein within the ZNI, one or more frequency bands are exclusively reserved for the one or more UWB transmissions during the one or more time windows.

8. The method of claim 1, wherein the UWB network device, before initiating the one or more UWB transmissions, increases a frame length of a UWB message based on one or more physical layer metrics.

9. The method of claim 1, wherein the UWB network device dynamically adjusts a threshold for CIR peak selection based on a density of the one or more WLAN transmissions in an environment.

10. The method of claim 1, wherein the WLAN device receives a message indicating a location of the UWB device, and nullifies the one or more WLAN transmissions towards the location of the UWB device using beamforming techniques.

11. The method of claim 1, wherein the WLAN device comprises an Access Point (AP), and the AP transmits a message to an associated client device indicating that the AP is in Low Power Idle (LPI) mode while the AP is actually in Stay-Put Idle (SPI) mode.

12. The method of claim 11, wherein the associated client device, after receiving the message, communicates with the AP using a reduced transmission power.

13. The method of claim 1, wherein the WLAN device comprises an Access Point (AP), and the AP reallocates the one or more WLAN transmissions to a second channel that does not overlap with a first channel used for the one or more UWB transmissions.

14. A system comprising:
one or more computer processors; and
one or more memories collectively containing one or more programs, which, when executed by the one or more computer processors, perform operations, the operations comprising:
receiving a synchronization schedule from an Ultra-wideband (UWB) network device;
analyzing the synchronization schedule to determine one or more timings for one or more UWB transmissions;
adjusting a schedule for one or more Wireless Local Area Network (WLAN) transmissions to avoid interference with the one or more UWB transmissions; and
communicating the adjusted schedule for the one or more WLAN transmissions to a WLAN device.

15. The system of claim 14, wherein the program, which, when executed on any combination of the one or more computer processors, performs the operations further comprising:
receiving a notification, from the UWB network device, indicating a UWB tag transmission; and
adjusting the schedule for the one or more WLAN transmissions to avoid interference with the UWB tag transmission.

16. The system of claim 14, wherein the program, which, when executed on any combination of the one or more computer processors, performs the operations further comprising establishing a Zone of Non-Interference (ZNI), wherein within the ZNI, one or more frequency bands are exclusively reserved for the one or more UWB transmissions.

17. The system of claim 14, wherein the program, which, when executed on any combination of the one or more computer processors, performs the operations further comprising:
determining one or more time windows based on the received synchronization schedule from the UWB network device; and
establishing a Zone of Non-Interference (ZNI), wherein within the ZNI, one or more frequency bands are exclusively reserved for the one or more UWB transmissions during the one or more time windows.

18. The system of claim 14, wherein the UWB network device, before initiating the one or more UWB transmissions, increases a frame length of a UWB message based on one or more physical layer metrics.

19. The system of claim 14, wherein the WLAN device comprises an Access Point (AP), and the AP transmits a message to an associated client device indicating that the AP is in Low Power Idle (LPI) mode while the AP is actually in Stay-Put Idle (SPI) mode.

20. One or more non-transitory computer-readable media containing, in any combination, computer program code that, when executed by operation of a computer system, performs operations comprising:
receiving a synchronization schedule from an Ultra-wideband (UWB) network device;
analyzing the synchronization schedule to determine one or more timings for one or more UWB transmissions;
adjusting a schedule for one or more Wireless Local Area Network (WLAN) transmissions to avoid interference with the one or more UWB transmissions; and communicating the adjusted schedule for the one or more WLAN transmissions to a WLAN device.
